(19) United States
(12) Patent Application Publication
(10) Pub. No.: US 2015/0003914 A1
(43) Pub. Date: Jan. 1, 2015

(54) MOUNTING FOR SCREED TEMPERATURE SENSOR

(71) Applicant: Caterpillar Paving Products Inc., Brooklyn Park, MN (US)

(72) Inventors: Anthony P. Steinhagen, Minneapolis, MN (US); Tobin D. Rasmusson, Bloomington, MN (US); Jameson M. Smieja, Mound, MN (US)

(21) Appl. No.: 13/929,992

(22) Filed: Jun. 28, 2013

(51) Int. Cl. G01K 1/14; G01K 13/04; E01C 19/22

(52) U.S. Cl. CPC G01K 1/14; E01C 19/22; G01K 13/04; E01C 2301/00
USPC 404/118

(57) ABSTRACT

A screed includes a frame and a plate, with the frame coupled to the plate. The plate has a top surface, a thickness, and an opening in the top surface. The opening extends into the thickness and is configured to receive at least a portion of a temperature sensor.

### TECHNICAL FIELD

The present disclosure relates generally to monitoring the temperature of a screed plate and, more particularly, to mounting a temperature sensor to a screed plate.

### BACKGROUND

A paving machine, such as an asphalt paver, is generally a self-propelled machine designed to receive, convey, distribute, and partially compact paving material, such as asphalt. Typically, the paving machine receives the paving material in a hopper positioned at the front of the machine, conveys the paving material from the hopper to the rear of the machine with parallel slat conveyors, distributes the paving material along a desired width, and compacts the paving material into a mat with a screed. The width of the screed, which may be adjustable, typically defines the paving width provided by the particular paving machine. In particular, some paving machines include frame portions that are hydraulically extendible in a substantially lateral direction to increase the paving width. Mechanical extensions, or screed extensions, may also be utilized for increasing the paving width provided by the base screed.

Asphalt material is more malleable at hot temperatures. When the asphalt material cools, it hardens and becomes much more difficult to shape and spread. The screed, extenders, and extensions, collectively referred to as a screed assembly, compact the asphalt material and create a finished mat. Asphalt material is provided to the paving machine at very hot temperatures (around 300 degrees Fahrenheit). If the temperature drops off too quickly, the paving machine will not be able to create a proper mat surface. For example, asphalt material being deposited at too cold a temperature could result in cracking, an uneven mat, and/or raveling. So to create a proper mat, the screed plate, extender plates, and extension plates are heated to maintain the asphalt material at a high temperature. Generally, heating elements are provided proximate to the top of the screed plate, extender plates, and extension plates to provide the required heat.

WO 2000047822 A1 to Williams et al. teaches a screed for a paver having a temperature sensor or sensors connected proximate to the screed plate for sensing temperature. The Williams reference teaches a screed for a paver having a temperature sensor or sensors connected proximate to the screed plate for sensing temperature. However, this method of measuring temperature is not always accurate and may lead to inefficient use of energy on the paving machine.

Temperature measurements from the temperature sensors are used to control the amount of energy provided to the heating elements, and thus the temperature of the screed plate. As a result, accurate measurements of the temperature of the screed plate are required to obtain a proper finished mat.

The present disclosure is directed to one or more of the problems or issues set forth above.

### SUMMARY OF THE DISCLOSURE

In one aspect, a screed includes a frame and a plate, with the frame coupled to the plate. The plate has a top surface, a thickness, and an opening in the top surface. The opening extends into the thickness and is configured to receive at least a portion of a temperature sensor.

In another aspect, a screed assembly includes a frame, a plate having a first thickness, an extender, and extender plate having a second thickness, and a first temperature sensor. The frame is coupled to the plate and the extender, and the extender is coupled to the extender plate. Additionally, the first temperature sensor is coupled to the plate and a portion of the first temperature sensor lies within the first thickness.

In yet another aspect, a paving machine includes a tractor and a screed assembly coupled to the tractor. The screed assembly includes a frame and a plate coupled to the frame. The plate has a thickness and a mating area, and the mating area is located at least partially within the thickness. The mating area is configured to receive a temperature sensor.

### BRIEF DESCRIPTION OF THE DRAWINGS

FIG. 1 is a perspective view of a paving machine having a screed with an extendible frame portion, according to the present disclosure;

FIG. 2 is a schematic view of a screed assembly, according to an aspect of the present disclosure;

FIG. 3 is a perspective view of a screed, according to another aspect of the present disclosure;

FIG. 4 is a sectional view of a temperature sensor coupled to a screed, according to one embodiment of the present disclosure;

FIG. 5 is a sectional view of a temperature sensor coupled to a screed, according to another embodiment of the present disclosure; and

FIG. 6 is a sectional view of a temperature sensor coupled to a screed, according to another embodiment of the present disclosure.

### DETAILED DESCRIPTION

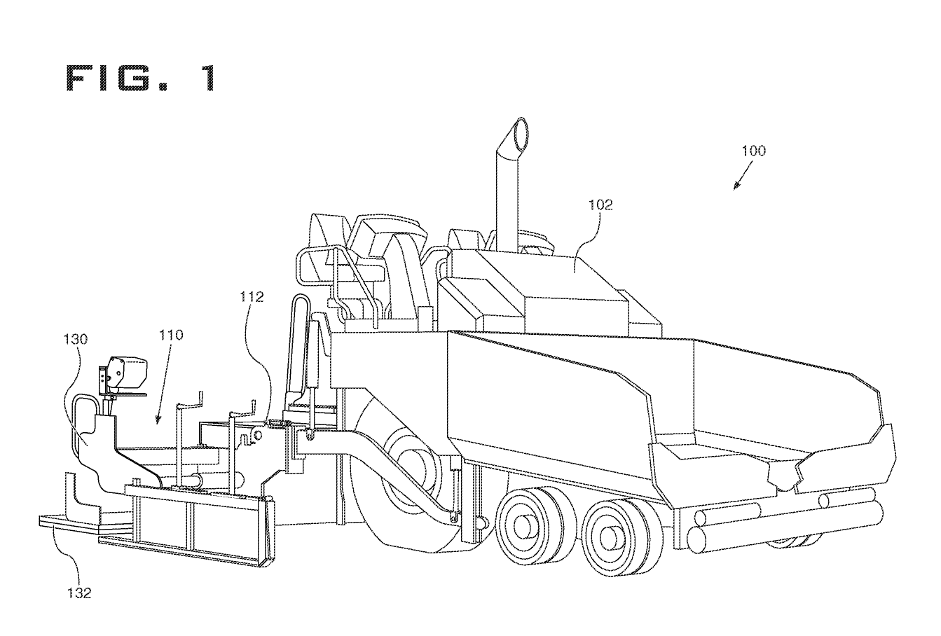

An exemplary embodiment of a paving machine 100 is shown generally in FIG. 1. Paving machine 100, which may also be referred to as an asphalt paver, may be any machine used to distribute a layer of paving material on the surface of a roadway or other area. Paving machine 100 generally includes a tractor portion 102 including a power source, such as an internal combustion engine, ground-engaging propulsion elements, some or all of which may be powered by the power source, and an operator control station. Paving machine 100 may also support various other components and systems, including a hopper supported on a front portion for receiving the paving material.

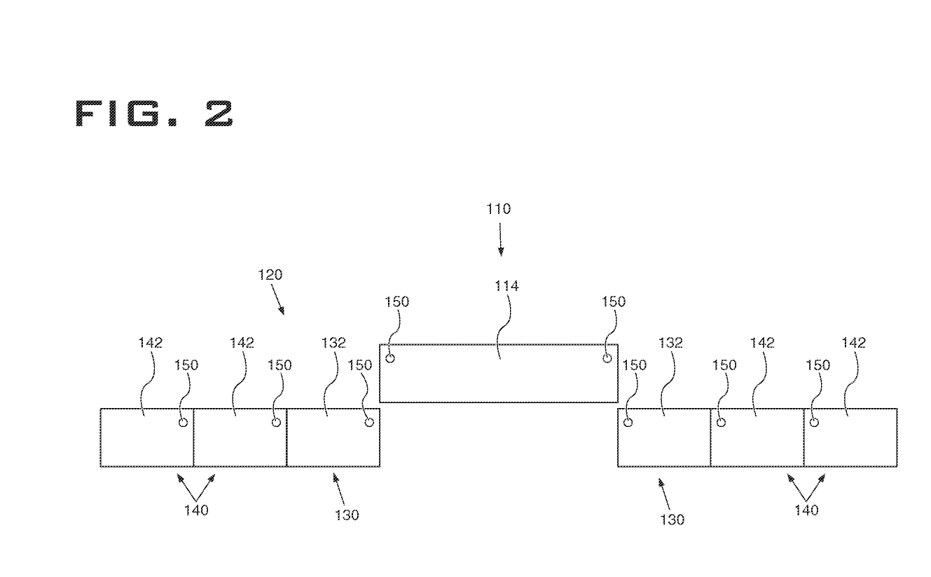

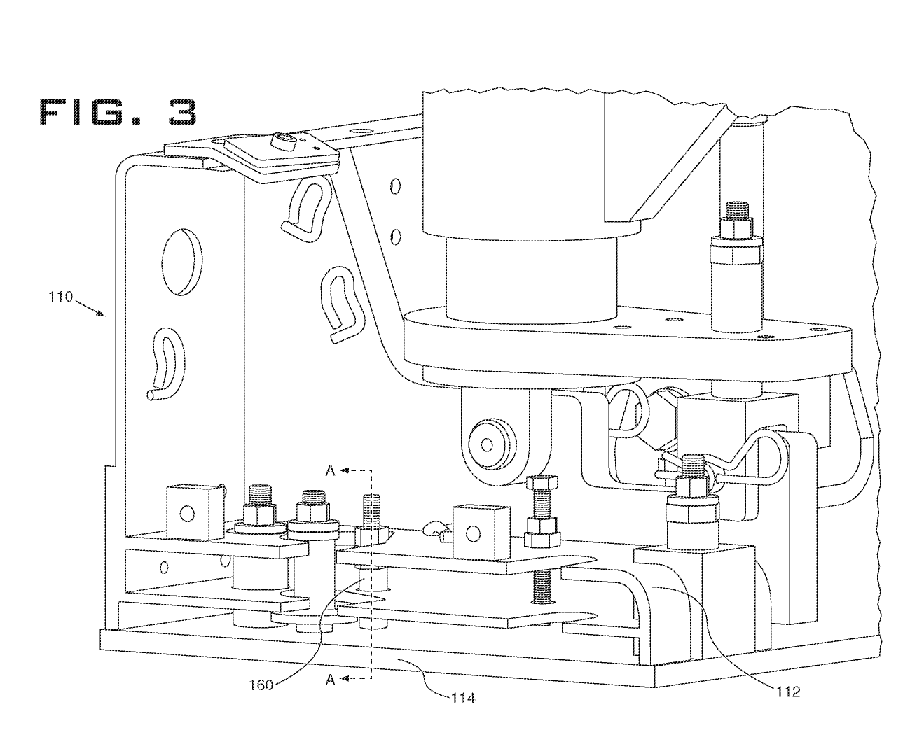

Paving machine 100 may also include a conveyor for conveying the paving material received within the hopper to a screed 110, such as a free floating screed, coupled with the paving machine 100, such as via tow arms, at a rear portion of the paving machine 100. Screed 110 may smooth and, at least partially, compact the paving material into a mat on the desired paving surface. Screed 110 may also include a frame 112 and a screed plate 114 (see FIGS. 2 and 3). Screed 110 may be capable of extending to allow for wider paving applications. In that case, screed 110 may include screed extender 130, which may include an extender plate 132. Screed extender 130 can be hydraulically actuated by the operator of paving machine 100 or screed 110 to widen and narrow as needed to lay the appropriate mat width for a particular paving job.

The tractor portion 102 of the paving machine 100 may also include hydraulic drives and controls, along with various other known paving machine components, for operating various systems and components of the paving machine 100. The screed 110 of the paving machine 100 may also include additional components and systems, such as, for example, leveling arms, vibrators, sensors, and controllers, as are known to those skilled in the art.

A schematic view of a screed assembly 120 is shown in FIG. 2. Screed assembly 120 includes screed 110 and screed extensions 140. Screed extensions 140 allow the operator to add additional paving width to paving machine 100. Screed extension 140 is typically bolted onto screed 110 at the end of screed extender 130. Further screed extensions 140 can be added to already installed screed extensions 140. For example, FIG. 2 shows one embodiment where two screed extensions 140 are attached to each side of screed 110 to form screed assembly 120. In FIG. 2, screed extenders 130 are shown extended and screed extensions 140 are attached to each side. While screed extensions 140 are shown as being of a uniform and equal length in FIG. 2, those of skill in the art will appreciate that screed extensions 140 may be of multiple and varying lengths. Additionally, while screed extension 140 is described as being bolted either to screed 110, screed extender 130, or screed extension 140, other methods of attachment are envisioned in this disclosure, as understood by those of skill in the art.

Screed 110 includes a screed plate 114 and extender plate 132, and screed extension 140 includes an extension plate 142. Screed plate 114, extender plates 132, and extension plates 142 are heated and used to finish the paving mat during the paving process. Provided in each of screed plate 114, extender plates 132, and extension plates 142 are openings 150. Openings 150 facilitate the mounting of a temperature sensor 160 (see FIGS. 3-6) to mount on each of screed plate 114, extender plates 132, and extension plates 142. The location of openings 150 on screed plate 114, extender plates 132, and extension plates 142 may vary depending on where heating elements, frame to plate connections, electrical connections, and other structural parts are located on screed assembly 120. According to one exemplary embodiment, the location of openings 150 is based upon where heat is distributed across screed plate 114, extender plates 132, and extension plates 142 to enable temperature sensor 160 to capture an accurate reading of the temperature of screed plate 114, extender plates 132, and extension plates 142.

According to one exemplary embodiment, openings 150 are threaded to allow temperature sensor 160 to be threaded into openings 150. Having openings 150 threaded also assist replacement of temperature sensor 160, should such a need arise. As one of skill in the art will appreciate, temperature sensor 160 can be any temperature sensor known in the art that is adapted to engage opening 150.

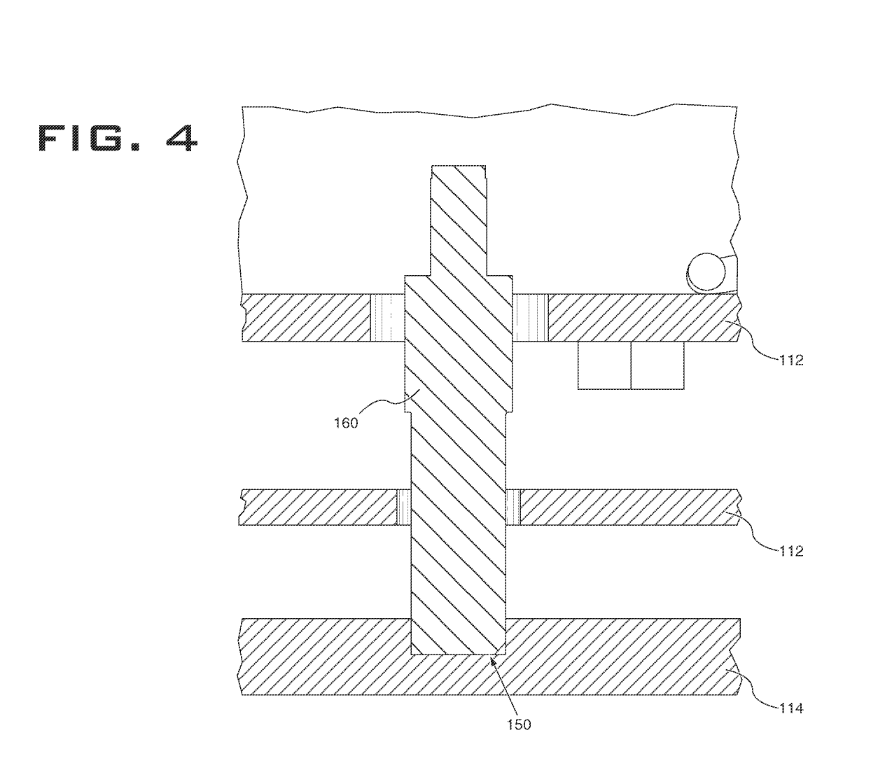

FIG. 3 shows a perspective view of screed 110 from a side view. Temperature sensor 160 is shown coupled to screed plate 114. In one embodiment, frame 112 includes apertures that allow temperature sensor 160 to extend through frame 112 without contacting frame 112. Sectional line A illustrates the cross-sectional view seen in the embodiments shown in FIGS. 4-6, each illustrating a cross section of temperature sensor 160.

FIG. 4 shows temperature sensor 160 coupled to screed plate 114 according to one exemplary embodiment. In this embodiment, opening 150 forms a recess that extends only partially into screed plate 114. Temperature sensor 160 is mounted within opening 150. Opening 150 may be threaded and configured to receive a corresponding threaded portion of temperature sensor 160. Alternatively, temperature sensor 160 may couple with screed plate 114 by welding, bolting, or other methods known in the art. Opening 150 may have different depths so as to position temperature sensor 160 within the thickness of screed plate 114, as will be explained in further detail.

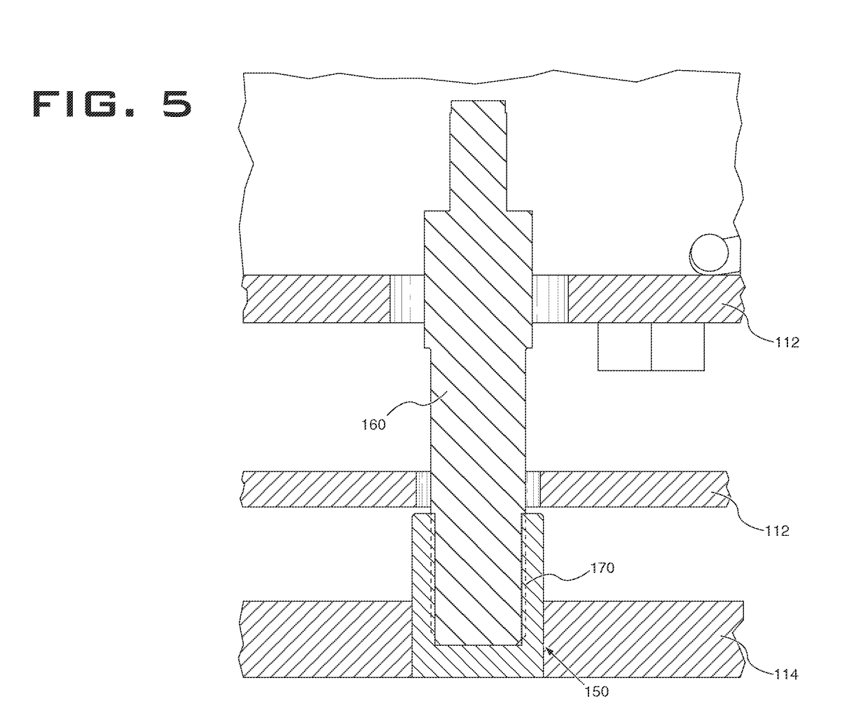

FIG. 5 shows temperature sensor 160 coupled to screed plate 114 according to another exemplary embodiment. In the embodiment, opening 150 extends all the way through screed plate 114. An adapter 170 is coupled to opening 150 and temperature sensor 160 is coupled to adapter 170 in such a way that temperature sensor 160 is positioned within opening 150. In one embodiment, adapter 170 may be threaded both externally, so it can be received within mating threads on opening 150, and internally, so that it can receive mating threads on temperature sensor 160, below the top surface of screed plate 114. Alternatively, temperature sensor 160 may couple with adapter 170 and/or screed plate 114 by welding, bolting, or other methods known in the art.

While the embodiment shown in FIG. 5 has opening 150 extending through the entire depth of screed plate 114 for use with adapter 170, opening 150 need not do so for adapter 170 to be used. Any arrangement of opening 150 and adapter 170 may be used so long as temperature sensor 160 lies within the thickness of screed plate 114, as will be explained in further detail. Opening 150 and/or adapter 170 form a mating area to couple temperature sensor 160 to screed plate 114.

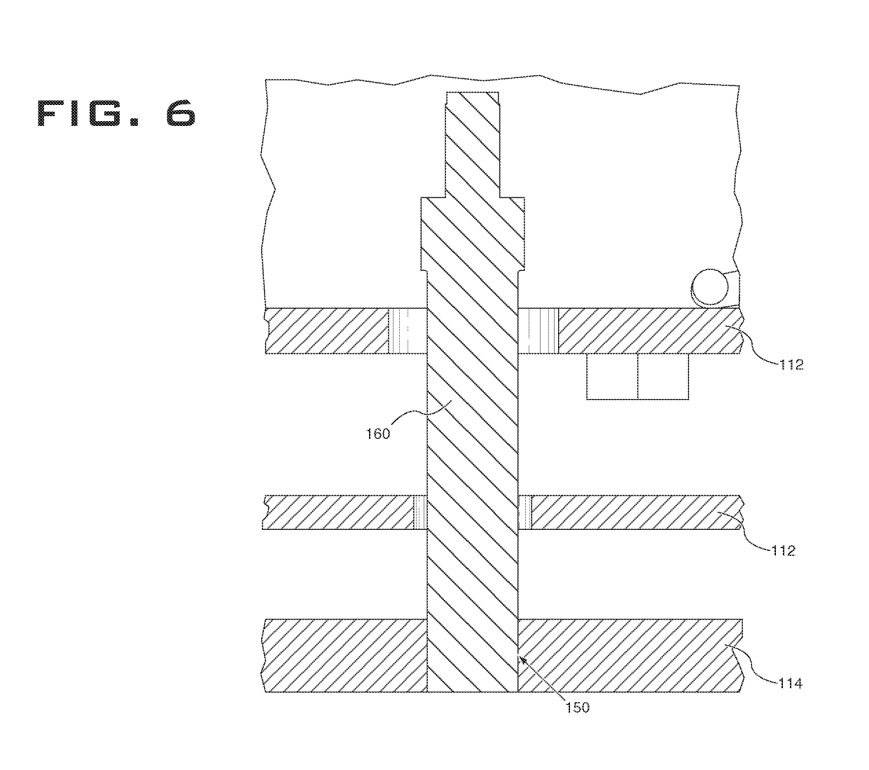

FIG. 6 shows temperature sensor 160 coupled to screed plate 114 according to another exemplary embodiment. In this embodiment, opening 150 extends fully through screed plate 114. Temperature sensor 160 is mounted within opening 150 so that its bottom surface is flush with the bottom surface of screed plate 114.

While FIGS. 4-6 show temperature sensor 160 mounted to screed plate 114, temperature sensor 160 may be mounted in a similar way to extender plate 132 and extension plate 142.

### INDUSTRIAL APPLICABILITY

The present disclosure finds potential application in any paving machine 100 that utilizes screed 110. During paving operations, it is important that an operator receives accurate readings of the temperature of screed plate 114. Having the thermistor bead located within the thickness of screed plate 114 (or extender plate 132 or extension plate 142) increases the accuracy of the measurements provided by temperature sensor 160. Mounting temperature sensor 160 to screed plate 114 (or extender plate 132 or extension plate 142) according to one of the embodiments of the present disclosure provides more accurate temperature readings then simply mounting a temperature sensor to the top of a screed plate as is known in the art.

Adapter 170 is made out of material, such as steel, that has no or very little thermal gradient, so that temperature sensor 160 is able to provide accurate temperature readings. A benefit to using adapter 170 instead of mounting temperature sensor 160 directly into screed plate 114 (or extender plate 132 or extension plate 142) is that adapter 170 provides a greater amount of engagement to temperature sensor 160, helping to maintain temperature sensor 160 in place.

As one of skill in the art will also appreciate, screed plate 114 (or extender plate 132 or extension plate 142) will wear during paving operations. The location of the sensor portion of temperature sensor 160 may be placed far enough above the bottom surface of screed plate 114 (or extender plate 132 or extension plate 142) so that it will not become damaged during extended paving operations.

The present disclosure provides more accurate temperature readings of screed plate 114 (or extender plate 132 or extension plate 142) than those known in the art. As a result, the present disclosure allows paving machine 100 to more efficiently regulate the use of electrical power to the heating elements and create a more even and better mat.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure, and the appended claims.

What is claimed is:

1. A screed comprising:
a frame; and
a plate, the plate comprising a top surface, a thickness, and an opening in the top surface;
wherein the frame is coupled to the plate;
wherein the opening extends into the thickness; and
wherein the opening is configured to receive at least a portion of a temperature sensor.

2. The screed of claim 1, further comprising:
a temperature sensor, the temperature sensor having a first length;
wherein the opening has a second length; and
wherein at least a portion of the first length occupies a portion of the second length.

3. The screed of claim 2, wherein at least a portion of the first length occupies the second length.

4. The screed of claim 2, wherein the screed further comprises:
an adapter;
wherein the adapter is coupled to the plate and coupled to the temperature sensor.

5. The screed of claim 2, wherein the thickness is equal to the second length.

6. A screed assembly comprising:
a frame;
a plate, the plate having a first thickness;
an extender;
an extender plate, the extender plate having a second thickness; and
a first temperature sensor;
wherein the frame is coupled to the plate;
wherein the frame is coupled to the extender;
wherein the extender is coupled to the extender plate; and
wherein the first temperature sensor is coupled to the plate and a portion of the first temperature sensor lies within the first thickness.

7. The screed assembly of claim 6, wherein the screed assembly further comprises:
a second temperature sensor; wherein the second temperature sensor is coupled to the extender plate and a portion of the second temperature sensor lies within the second thickness.

8. The screed assembly of claim 7, wherein the screed assembly further comprises:
a third temperature sensor; wherein the third temperature sensor is coupled to the plate and a portion of the third temperature sensor lies within the first thickness.

9. The screed assembly of claim 8, wherein the plate has a first end and a second end, and the first temperature sensor is located proximate to the first end and the third temperature sensor is located proximate to the second end.

10. The screed assembly of claim 9, wherein the screed assembly further comprises a fourth temperature sensor;
wherein the extender comprises a first extender frame and a second extender frame;
wherein the extender plate comprises a first extender plate and a second extender plate;
wherein the first extender frame is coupled to the first extender plate and located adjacent to the first end;
wherein the second extender frame is coupled to the second extender plate and located adjacent to the second end;
wherein the second temperature sensor is coupled to the first extender plate and a portion of the second temperature sensor lies within the second thickness; and
wherein the fourth temperature sensor is coupled to the second extender plate and a portion of the fourth temperature sensor lies within the second thickness.

11. The screed assembly of claim 10, the screed assembly further comprising:
a first adapter;
a second adapter;
a third adapter; and
a fourth adapter;
wherein the first adapter is coupled to the plate and the first adapter holds a portion of the first temperature sensor;
wherein the second adapter is coupled to the first extender plate and holds a portion of the second temperature sensor;
wherein the third adapter is coupled to the plate and the third adapter holds a portion of the third temperature sensor; and
wherein the fourth adapter is coupled to the second extender plate and holds a portion of the fourth temperature sensor.

12. The screed assembly of claim 10, the screed assembly further comprising an extension, the extension comprising:
an extension frame;
an extension plate, the extension plate having a third thickness; and
a fifth temperature sensor;
wherein the fifth temperature sensor is coupled to the extension plate and a portion of the fifth temperature sensor lies within the third thickness.

13. The screed assembly of claim 12, the screed assembly further comprising:
a fifth adapter;
wherein the fifth adapter is coupled to the extension plate and the fifth adapter holds a portion of the fifth temperature sensor.

14. A paving machine, the paving machine comprising:
a tractor; and
a screed assembly coupled to the tractor, the screed assembly comprising:
a frame; and
a plate coupled to the frame, the plate comprising a thickness and a mating area;
wherein the mating area is located at least partially within the thickness; and
wherein the mating area is configured to receive a temperature sensor.

15. The paving machine of claim 14, the screed assembly further comprising:
a temperature sensor, wherein the temperature sensor is coupled with the mating area and at least a portion of the temperature sensor lies within the thickness.

16. The paving machine of claim 15, wherein the mating area extends through the entire thickness.

17. The paving machine of claim 15, wherein the mating area comprises an adapter, wherein the adapter couples with the temperature sensor.

18. The paving machine of claim 15, the screed assembly further comprising an extender portion, wherein the extender portion comprises:
an extender frame;
an extender plate coupled to the extender frame, the extender plate comprising a second thickness and a second mating area located at least partially within the second thickness; and
a second temperature sensor;
wherein the extender portion is coupled to the frame;
wherein the second temperature sensor is coupled to the second mating area, and at least a portion of the second temperature sensor lies within the second thickness.

19. The paving machine of claim 18, the screed assembly further comprising an extension portion, wherein the extender portion comprises:
an extension frame;
an extension plate, the extension plate comprising a third thickness and a third mating area; and
a third temperature sensor;
wherein the extension portion is coupled to the extender portion;
wherein the extension frame is coupled to the extension plate;
wherein the third mating area is located at least partially within the third thickness;
wherein the third temperature sensor is coupled to the third mating area, and at least a portion of the third temperature sensor lies within the third thickness.

20. The paving machine of claim 19, wherein the second mating area comprises a second adapter and the third mating area comprises a third adapter; wherein the second adapter couples to the second temperature sensor and the third adapter couples to the third temperature sensor.
